(19) United States
(12) Patent Application Publication
(10) Pub. No.: US 2007/0005170 A1
(43) Pub. Date: Jan. 4, 2007

(54) Method for the preferred processing of workpieces of highest priority

(76) Inventor: Thorsten Schedel, Dresden (DE)

Correspondence Address: SLATER & MATSIL LLP, 17950 PRESTON ROAD, SUITE 1000, DALLAS, TX, 75252, US

(21) Appl. No.: 11/170,191

(22) Filed: Jun. 29, 2005

(51) Int. Cl. G06F 19/00

(52) U.S. Cl. 700/101; 700/99

(57) ABSTRACT

A method is provided for the preferred processing of a workpiece of highest priority in a plant with a number of processing steps and at least one processing station for each processing step. A workpiece of highest priority to be added is inserted at the head of the line before the first processing step and is passed to the next processing station of this processing step that becomes free. For each subsequent processing step, a processing station of this processing step is kept free or preallocated. In the event that there are a number of processing stations for a processing step, the one which experiences the shortest standstill time on account of being kept free or at which the workpiece of highest priority experiences the shortest waiting time on account of it being preallocated being selected from among these processing stations. The workpiece of highest priority is passed on to the processing station kept free or preallocated and is once again inserted at the head of the line.

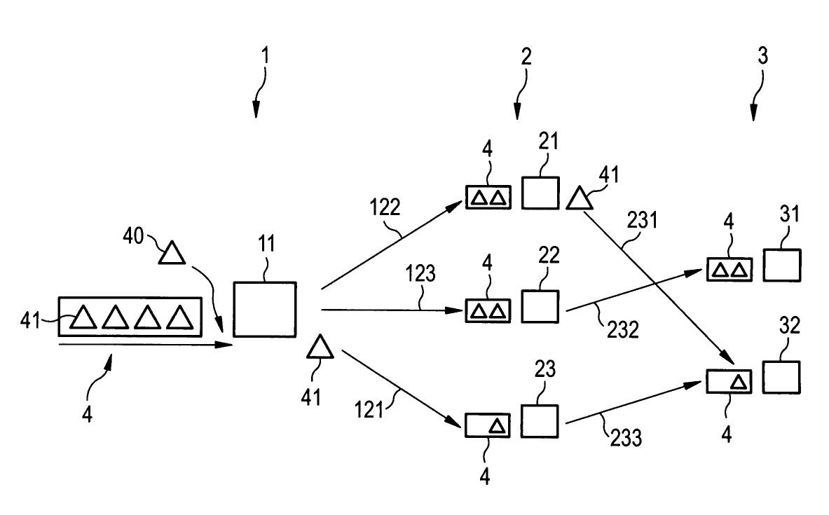

### TECHNICAL FIELD

The invention relates to a method for the preferred processing of workpieces of highest priority and to a method for the preferred processing of batches of highest priority.

### BACKGROUND

In semiconductor processing plants, high plant utilization is of great importance to allow cost-effective production. For this purpose, modern fabs have control systems that organize the throughput of the wafers, which are passed through the fab in so-called Front Opening Unified Pods (FOUP). Each FOUP can hold a plurality of wafers, which is referred to as a batch. A fab comprises a number of processing stations each for performing a method step, which are connected to one another by transporting devices in such a way that a FOUP passes successively through all the processing stations that are required for processing the wafers. Individual processing stations may also be present more than once, to allow for different process times of individual processing stations or different frequencies of individual method steps.

To avoid waiting times of the batches at the next processing station and idle times of the processing stations, various methods are known, described for example in U.S. Pat. No. 6,687,563 and U.S. Pat. No. 5,612,886, which are incorporated herein by reference.

Both to evaluate existing processes that are run through by batches in the fab and to optimize new processes or to ramp up the fab, it is necessary to process individual batches with highest priority. The experience and results obtained from the throughput of such batches of highest priority provide important findings for increasing the productivity of the fab.

However, throughput time violations often occur here, since logistic prerequisites for the fastest possible throughput of the batches of highest priority cannot be optimally prepared. This may have the result, for example, that a processing station is occupied when the batch of highest priority arrives, because the prediction of the arrival of this batch was not known sufficiently precisely.

For optimum planning of the throughput of a workpiece or a batch of highest priority, it must be known how long the available processing stations will continue to be occupied with the workpieces or batches currently being processed, whether the processing of the workpiece or batch being processed at the particular time is proceeding undisturbed and when it will be completed, how long the workpiece or batch of highest priority still requires to arrive at the next processing station and whether the time until the arrival of the workpiece or batch of highest priority at a specific processing station is still sufficient to process a workpiece or batch of lower priority.

Most of this information is at present estimated with the aid of software tools, which simply compare theoretically stored plan values with the currently proceeding situation. However, this preparatory work is time-consuming and very prone to errors. In particular, unplanned events such as downtimes of a processing station (tool downtimes) cannot be taken into account by this method.

### SUMMARY OF THE INVENTION

In one aspect, the present invention provides a method for the preferred processing of workpieces or batches of highest priority, which permits the lowest possible throughput time of such batches through a fab.

For reasons of simplicity, hereafter reference is only made to workpieces. However, the method according to embodiments of the invention is not restricted to individual workpieces but is suitable in the same way for the speedier processing of batches. The application of the method according to embodiments of the invention to processing processes in which a number of workpieces are combined into batches is, therefore, covered by the statements made below and is likewise claimed.

In the case of the method according to embodiments of the invention for the preferred processing of a workpiece of highest priority in plants with a number of processing steps and at least one processing station for each processing step, each workpiece runs through a number of processing steps, and is assigned a priority. The workpieces are arranged in a line ordered according to their priority. After the end of one processing step, each workpiece is passed for the performance of the next processing step to the next processing station becoming free. It is provided that a workpiece of highest priority to be added is inserted at the head of the line before the first processing step and is passed to the next processing station of this processing step that becomes free. For each subsequent processing step, the at least one processing station of this processing step is kept free or preallocated. In the event that there are a number of processing stations for a processing step, the one that experiences the shortest standstill time on account of being kept free or at which the workpiece of highest priority experiences the shortest waiting time on account of it being preallocated is selected from among these processing stations. The workpiece of highest priority is passed on to the processing station kept free or preallocated and is once again inserted at the head of the line there. After its arrival at the processing station kept free or preallocated, the workpiece of highest priority can be processed immediately or after a short waiting time.

The normal throughput of workpieces through the processing stations of the plant takes place in such a way that the workpieces are arranged in the line in the sequence of their arrival at the first processing station and are subsequently dealt with in this sequence. Individual workpieces may additionally be assigned a higher priority, so that they are always pushed to the front in the line if this is technologically possible, for example whenever there is a waiting time before a processing step because the processing station has not yet finished with the previous batch or if a workpiece can be passed to one of a number of processing stations according to choice.

If a workpiece of highest priority is then added, it is immediately arranged at the head of the line before the first processing step, so that it is the next to be processed. If a number of processing stations are available for the first processing step, the workpiece of highest priority is passed to the processing station that first becomes free.

During the processing of the workpiece of highest priority, a processing station of each subsequent processing step is kept free or preallocated for each subsequent processing step that is planned for the workpiece of highest priority. According to embodiments of the invention, preplanning is performed with the method according to embodiments of the invention, in that a processing station that is required for a subsequent processing step is either kept free or preallocated.

If it is established that the next processing station is still occupied with the processing of another workpiece when the workpiece of highest priority arrives, the processing of this other workpiece is no longer begun, i.e. the processing station is kept free. If, on the other hand, the time until the arrival of the workpiece of highest priority is still adequate for the processing of another workpiece from the line, its processing is started and the processing station is subsequently kept free for the workpiece of highest priority.

If it is no longer possible for the processing station to be kept free, because the processing of the workpiece currently located in the processing station can no longer be completed before the arrival of the workpiece of highest priority, the processing station is preallocated, i.e., information that the workpiece of highest priority is to be processed immediately after completion of the processing of the previous workpiece, irrespective of whether other workpieces are ahead of the workpiece of highest priority in the line, is sent to the processing station.

If there are a number of processing stations for a subsequent processing step, i.e., a processing step still to be run through by the workpiece of highest priority, the one that experiences the shortest standstill time on account of being kept free or at which the workpiece of highest priority experiences the shortest waiting time on account of it being preallocated is selected from among these processing stations.

If, for example, only one of three identical processing stations can be kept free, but the other two can only be preallocated, the processing station that can be kept free is selected and kept free. The other two processing stations continue to deal with the workpieces of the line uninfluenced. If more identical processing stations can be kept free, the one that has the shortest standstill time as a result of being kept free is selected and kept free.

As soon as it is established which processing station has been selected for the processing of the workpiece of highest priority, this workpiece is passed to the selected processing station, i.e., the processing station kept free or preallocated, and is once again arranged at the head of the line there. In this way, the method according to embodiments of the invention achieves the effect that, after its arrival at the selected processing station, the workpiece of highest priority can be processed immediately or after the shortest possible waiting time.

In a refinement of the method it is provided that, at predeterminable intervals, the time t_{Am} of its possible arrival at each processing station m of the next processing step is calculated for the workpiece of highest priority, the time t_{m,n} of the end of processing each workpiece n=1 . . . N+1 of the line is calculated for each existing processing station m=1 . . . M of the next processing step, and the difference D_{m,n}=t_{Am}−t_{m,n} is calculated until D_{m,N+1} assumes a negative value, where n=1 refers to the workpiece currently being processed and where N refers to the number of workpieces for which the processing on the processing station m can be completed before the arrival of the workpiece of highest priority, the processing station m of the next processing step that has the smallest non-negative value of D_{m,N} being selected if at least one non-negative D_{m,N} exists, and the processing station m of the next processing step that has the smallest absolute value of D_{m,N} being selected if no non-negative D_{m,N} exists.

The preplanning of the throughput of the workpiece of highest priority is dynamically updated in this way, so that it is possible to respond flexibly to unforeseen events. In this respect, the difference between the expected arrival of the workpiece of highest priority and the expected remaining running time of the processing of another workpiece in the processing station being considered is proposed as a criterion of the decision for the selection of the processing station of the next processing step that is to be used.

The repeated calculation of this difference allows the processing station that ensures the quickest possible throughput of the workpiece of highest priority always to be selected. In this respect, a positive value of the difference means that the processing station must be kept free. A negative value of the difference means that the workpiece of highest priority must wait ahead of this processing station for the beginning of processing. If the value of the difference is equal to zero, the workpiece of highest priority arrives precisely at the time when the processing station is completing the processing of another workpiece. Positive values and zero are referred to as non-negative values.

If the difference is positive and greater than the time that is required for the processing of one or more other workpieces from the line, these workpieces can still be processed. If the value of the calculated difference for this processing station after dealing with the other workpieces of all the identical processing stations is the smallest, this processing station is selected, otherwise another processing, which has the smallest non-negative difference, is selected. Only if there is no processing station with a non-negative difference is the processing station for which the negative difference has the smallest absolute value selected, so that the waiting time for the workpiece of the highest priority is as short as possible.

It may advantageously also be provided that, in the calculation of the times t_{Am} and t_{m,n}, current information on the expected end of the respective processing step is taken into account, estimated directly before the calculation Of t_{Am} and t_{m,n} on the basis of the remaining processing time in the respective processing step, which is dependent on the size and number of the workpieces currently being processed, the time requirement for special processing steps, technologically caused waiting times, manual or automatic interruptions and planned and unplanned downtimes of the respective processing station on account of servicing work, power failures or breakdowns.

This measure significantly increases the accuracy and reliability of the preplanning, because it takes into account factors, which inflexible throughput planning cannot compensate. Planned events that take place independently of the processing of the workpiece of highest priority but influence its throughput, and unplanned events that disturb an initially optimum plan lead to a correction of the preplanning, so that the shortest possible throughput time is always achieved for the workpiece of highest priority.

It may advantageously also be provided that at least one further processing station of the same processing step is selected and kept free or preallocated, the processing station that experiences the shortest standstill time on account of being kept free or at which the workpiece of highest priority experiences the shortest waiting time on account of it being preallocated being selected from among the not yet selected processing stations.

This measure creates a fallback position, which ensures that a processing station is available for the processing of the workpiece of highest priority even if, for unforeseeable reasons, the selected processing station with the shortest standstill time or waiting time fails and is no longer available shortly before the arrival of the workpiece of highest priority. In this case, the processing station that permits the shortest possible throughput of the workpiece of highest priority becomes the second selected processing station.

In a refinement of the method, it is further provided that, for all the selected processing stations, the standstill times of the processing station or the waiting times of the workpieces of highest priority are recorded and stored for evaluation purposes.

The recording and evaluation of the data permits the implementation of learning processes for further optimization of the preplanning by the method according to embodiments of the invention.

### BRIEF DESCRIPTION OF THE DRAWINGS

The invention is explained in more detail below on the basis of an exemplary embodiment and associated drawing. In these, the single FIGURE shows a fab with three processing steps.

### DETAILED DESCRIPTION OF ILLUSTRATIVE EMBODIMENTS

The fab is designed by way of example for performing three processing steps, one processing station 11 being provided for the processing step 1, three processing stations 21, 22, 23 being provided for the processing step 2 and two processing stations 31, 32 being provided for the processing step 3.

The number of processing stations of each processing step is chosen such that the throughput of each processing step of the fab is equal in size, provided that no disturbance occurs. Ahead of each processing station there forms a new line 4 of batches 41, which are waiting for their processing. In this context, a batch is a plurality of workpieces combined into a unit for the purpose of processing.

Ahead of the processing station 11 of the first processing step 1, a line 4 of batches of normal priority 41 has formed. These batches 41 are generally dealt with in the sequence of their position in the line 4.

The batches 41 are uniformly distributed between the processing stations 21, 22, 23 or 31, 32, respectively, and in turn arrange themselves there into a line 4. When a batch 41 leaves a processing station 21, 22, 23 or 31, 32, the batch 41 arranged at the forwardmost position in the respective line 4 is subsequently taken immediately for processing.

If a batch of highest priority 40 then arrives, its processing in the fab is performed as follows.

Firstly, the batch of highest priority 40 is arranged at the head of the line 4 immediately before the first processing step 1, so that it is processed before all the other waiting batches 41 as soon as the processing station 11 becomes free.

While the batch of highest priority 40 is being processed in the processing station 11, one of the processing stations 21, 22, 23 is kept free or preallocated for the processing step 2.

For this purpose, at predeterminable intervals, the times t_{A21}, t_{A22} and t_{A23} of the arrival at each processing station 21, 22, 23 of the second processing step 2 are calculated for the batch of highest priority 40. At the same time, the times t_{21,n}, t_{22,n} and t_{23,n} of the end of processing each batch 41 of the line 4 before the batch of highest priority 40 are calculated for each processing station 21, 22, 23 of the second processing step 2, the variable n representing a counting variable assigned to each batch 41 and the batch with n=1 referring to the batch currently being processed on the respective processing station. From the values determined in this way, n differences D_{21,n}=t_{A21}−t_{21,n} are calculated for the processing station 21 and, by an analogous specification, in each case n differences D_{22,n} and D_{23,n} are calculated for the processing stations 22 and 23, respectively.

For each processing station 21, 22, 23 there is obtained for a specific value of n, which is defined here as N+1, a negative value for the difference D, which indicates that the batch with the number N+1 can no longer be processed to completion on this processing station before the arrival of the batch of highest priority.

The values of D calculated for each processing station for the batch N, i.e., the last non-negative values obtained for batches for which the processing can still be completed before the arrival of the batch of highest priority 40, are compared with one another. The smallest value of D indicates which processing station must be kept free for the batch of highest priority 40. This processing station has the smallest standstill time by being kept free.

In the exemplary embodiment, it is assumed that
D_{21,N+1}=−80 min. and D_{21,N}=10 min.
D_{22,N+1}=−50 min. and D_{22,N}=40 min.
D_{23,N+1}=−20 min. and D_{23,N}=70 min.

In this case, the processing station 21 is to be kept free after completion of the processing of the batch N, since an idle time of only 10 minutes has to be accepted as a result, while processing station 22 would have to be at a standstill for as much as 40 minutes and processing station 23 for even 70 minutes.

This calculation is repeated at intervals until the actual arrival of the batch 40 at the processing station 21. If the processing is delayed on one or more processing stations, new information may be provided. For example
D_{22,N+1}=−90 min. and D_{21,N}=0 min.
D_{22,N+1}=−60 min. and D_{22,N}=30 min.
D_{23,N+1}=−30 min. and D_{23,N}=60 min.

In this case, the processing station 21 likewise has to be kept free after completion of the processing of the batch N, since the batch 40 is expected to arrive precisely at the time at which the processing of the Nth batch is being completed.

It also follows from this that N further batches (including the one currently being processed) can be processed at the processing stations 21, 22, 23 before the arrival of the batch of highest priority 40.

If, however, N+1=1 for all the processing stations, i.e. if already at the beginning of the processing of the batch of highest priority 40 in the processing station 11 the batches 41 currently being processed in the processing stations 21, 22, 23 cannot be completed by the arrival of the batch of highest priority 40, the processing station for which the difference D has the smallest absolute value, for example
D_{21,1}=−70 min.
D_{22,1}=−40 min.
D_{23,1}=−10 min.,
is to be selected for the processing station and preallocated for the processing of the batch of highest priority 40.

In this case, the batch of highest priority 40 would only have to wait 10 minutes at processing station 23 before the beginning of the processing, while waiting times of 70 and 40 minutes would occur at the processing stations 21 and 22, respectively. Therefore, processing station 23 should be preallocated since, in the case of this example N+1=1, there is no batch with the counting index N for any of the processing stations 21, 22, 23. Accordingly, no further batches can be processed at the processing stations 21, 22, 23 before the arrival of the batch of highest priority 40.

If the processing of the batch of highest priority 40 on a processing station 21, 22, 23 of the second processing step 2 has begun, the processing station 31, 32 of the third processing step 3 that is to be kept free or preallocated is determined at intervals in an analogous way.

With the preplanning according to embodiments of the invention of the throughput of the batch of highest priority 40, it is possible to respond flexibly to unforeseen events. The calculation repeated at intervals has the effect that the processing station that ensures the quickest possible throughput of the batch of highest priority 40 through the fab is always selected.

What is claimed is:

1. A method for the preferred processing of a workpiece of highest priority in plants with a number of processing steps and at least one processing station for each processing step, each workpiece running through a number of processing steps, each workpiece being assigned a priority, the workpieces being arranged in a line ordered according to their priority and, after the end of one processing step, each workpiece being passed for the performance of the next processing step to the next processing station becoming free, the method comprising:
inserting a workpiece of highest priority at the head of the line before the first processing step and passing said workpiece of highest priority to the next processing station of this processing step that becomes free,
for each subsequent processing step:
preallocating or keeping free a processing station of that processing step, wherein, in the event that there are a number of processing stations for that processing step, the one which experiences the shortest standstill time on account of being kept free or at which the workpiece of highest priority experiences the shortest waiting time on account of it being preallocated being selected from among these processing stations; and
passing the workpiece of highest priority on to the processing station kept free or preallocated and inserting the workpiece of highest priority at the head of the line, such that, after its arrival at the processing station kept free or preallocated, the workpiece of highest priority can be processed immediately or after a short waiting time.

2. The method of claim 1, wherein the workpieces comprise semiconductor wafers and wherein the processing steps comprise semiconductor processing steps.

3. A method for the preferred processing of a workpiece of highest priority in plants with a number of processing steps and at least one processing station for each processing step, each workpiece running through a number of processing steps, each workpiece being assigned a priority, the workpieces being arranged in a line ordered according to their priority and, after the end of one processing step, each workpiece being passed for the performance of the next processing step to the next processing station becoming free, comprising the method, at predeterminable intervals,
calculating a time t_{Am} of its possible arrival at each processing station m of the next processing step for the workpiece of highest priority;
calculating a time t_{m,n} of the end of processing each workpiece, where n=1 . . . N+1 of the line for each existing processing station and m=1 . . . M of the next processing step;
calculating a difference D_{m,n}=t_{Am}−t_{m,n} until D_{m/N+1} assumes a negative value, where n=1 refers to the workpiece currently being processed and where N refers to the number of workpieces for which the processing step the processing station m can be completed before the arrival of the workpiece of highest priority;
selecting a processing station m of the next processing step that has the smallest non-negative value of D_{m,N} if at least one non-negative D_{m,N} exists; and
selecting the processing station of the next processing step that has the smallest absolute value of D_{m,N} if no non-negative D_{m,N} exists.

4. The method as claimed in claim 3, in which, in the calculation of the times t_{Am} and t_{m,n}, current information on an expected end of the respective processing step is taken into account.

5. The method as claimed in claim 4, wherein the current information is estimated directly before the calculation of t_{Am} and t_{m,n} on the basis of a remaining processing time in the respective processing step, the remaining processing time being dependent on the size and number of the workpieces currently being processed.

6. The method as claimed in claim 4, wherein the current information is estimated directly before the calculation of t_{Am} and t_{m,n} on the basis of a time requirement for special processing steps.

7. The method as claimed in claim 4, wherein the current information is estimated directly before the calculation of t_{Am} and t_{m,n} on the basis of technologically caused waiting times.

8. The method as claimed in claim 4, wherein the current information is estimated directly before the calculation of t_{Am} and t_{m,n} on the basis of manual or automatic interruptions.

9. The method as claimed in claim 4, wherein the current information is estimated directly before the calculation of t_{Am} and t_{m,n} on the basis of planned and unplanned downtimes of the respective processing station on account of servicing work, power failures or breakdowns.

10. The method of claim 3, wherein the workpieces comprise semiconductor wafers and wherein the processing steps comprise semiconductor processing steps.

11. A method for the preferred processing of a workpiece of highest priority in plants with a number of processing steps and at least one processing station for each processing step, each workpiece running through a number of processing steps, each workpiece being assigned a priority, the workpieces being arranged in a line ordered according to their priority and, after the end of one processing step, each workpiece being passed for the performance of the next processing step to the next processing station becoming free, in which method at least one further processing station of the same processing step is selected and kept free or preallocated, the processing station that experiences a shortest standstill time on account of being kept free or at which the workpiece of highest priority experiences the shortest waiting time on account of it being preallocated being selected from among the not yet selected processing stations.

12. The method of claim 11, wherein the workpieces comprise semiconductor wafers and wherein the processing steps comprise semiconductor processing steps.

13. A method for the preferred processing of a workpiece of highest priority in plants with a number of processing steps and at least one processing station for each processing step, each workpiece running through a number of processing steps, each workpiece being assigned a priority, the workpieces being arranged in a line ordered according to their priority and, after the end of one processing step, each workpiece being passed for the performance of the next processing step to the next processing station becoming free, in which method, for all the selected processing stations, the standstill times of the processing station or the waiting times of the workpieces of highest priority are recorded and stored for evaluation purposes.

14. The method of claim 13, wherein the workpieces comprise semiconductor wafers and wherein the processing steps comprise semiconductor processing steps.
